(19) United States
(12) Patent Application Publication
(10) Pub. No.: US 2008/0195800 A1
(43) Pub. Date: Aug. 14, 2008

(54) Flash Memory Device and Flash Memory System Including a Buffer Memory

(75) Inventors: Sang-Woo Lee, Gyeonggi-do (KR); Bum-Seok Yu, Gyeonggi-do (KR); Kwang-Seok Im, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/018,991

(22) Filed: Jan. 24, 2008

(30) Foreign Application Priority Data
Feb. 8, 2007 (KR) 2007-12985

(51) Int. Cl. G06F 12/02; G06F 13/28

(52) U.S. Cl. 711/103; 710/22; 711/E12.008

(57) ABSTRACT

A flash memory device includes a flash memory, a buffer memory and a control unit. The buffer memory temporarily stores data that is to be stored in the flash memory or data that is read from the flash memory. The control unit includes a buffer controller. The buffer controller performs a jump operation for transferring data unnecessary to be updated in the flash memory to an adjacent position of update data in the buffer memory when a size of data necessary to be updated in the flash memory is smaller than a size of a block of the flash memory. Therefore, the flash memory device and a flash memory system including the flash memory device may simplify an update operation with a DMA operation and a performance of a system is enhanced.

### CROSS-REFERENCE TO RELATED APPLICATIONS

This application claims priority under 35 USC §119 to Korean Patent Application No. 2007-12985 filed on Feb. 8, 2007 in the Korean Intellectual Property Office (KIPO), the disclosure of which is incorporated herein in its entirety by reference.

### FIELD OF THE INVENTION

The present invention relates to a flash memory device, and more particularly to a flash memory device and a flash memory system including a buffer memory and a method of updating data in the flash memory device.

### BACKGROUND OF THE INVENTION

A flash memory is a nonvolatile memory that may be integrated with large scale. The flash memory may be used as a main memory and/or a main storage device of a system because the flash memory is excellent in preserving data. The flash memory may be applied to a dynamic random access memory (DRAM) interface or a static random access memory (SRAM) interface. The flash memory may be substituted for a hard disk and/or a floppy disk, which have a large scale and massive storage capability. The flash memory is used as a storage device in mobile digital electronic machines such as a cellular phone, a digital camera, an mp3 player, a camcorder, a personal digital assistant (PDA), etc. However, a read time and a write time of the flash memory are longer than a read time and a write time of a random access memory (RAM), and the flash memory cannot be randomly accessed. A buffer memory may be included in the flash memory device to overcome the fault of the flash memory that cannot be randomly accessed. The buffer memory may be implemented with the random access memory such as a DRAM or a SRAM.

In the flash memory device including the buffer memory, data received from a host is stored in the buffer memory and then the data of the buffer memory is stored in the flash memory. In the same manner, data of the flash memory is stored in the buffer memory and then the data of the buffer memory is transmitted to the host.

The buffer memory is required to temporarily store data before the data is written to the flash memory or before the data of the flash memory is transmitted to the host, thereby supporting indirectly the random access of the flash memory.

However, unnecessary operation is performed when data of the flash memory is updated when a size of the data is smaller than a size of the block because an erase operation is performed by a block unit.

FIGS. 1A through 1D are diagrams illustrating a process of updating data in a conventional flash memory device including a buffer memory.

Referring to FIG. 1A, data 14 necessary to be updated and data 15 unnecessary to be updated are included in data 18 of the flash memory 20, and update data 12 is included in the buffer memory 10.

Referring to FIG. 1B, the data 18 in the flash memory is transferred to the buffer memory 10 and the data 14 is replaced with the update data 12. Data may be updated in the buffer memory 10 by using an additional memory or by a first-in first-out (FIFO) process since internal data transfer is impossible in the buffer memory 10. An erase operation is performed in the flash memory 20 by a block unit.

Referring to FIG. 1C, the updated data 19 is programmed to the erased block or another block of the flash memory 20. FIG. 1D represents the state of the flash memory 20 in which the update operation is finished.

In the conventional flash memory device, the update operation is complex and performance of a system is degraded because the additional memory or the FIFO process is required.

### SUMMARY OF THE INVENTION

Accordingly, the present invention is provided to substantially obviate one or more problems due to limitations and disadvantages of the related art.

Some example embodiments of the present invention may provide a flash memory device including a buffer memory capable of updating of data with a direct memory access (DMA) operation.

Some example embodiments of the present invention may provide a flash memory system including the flash memory device.

Some example embodiments of the present invention may provide a method of updating data of the flash memory device with a DMA operation. In some example embodiments of the present invention, a flash memory device includes a flash memory, a buffer memory and a control unit. The buffer memory temporarily stores data that is to be stored in the flash memory or data that is read from the flash memory. The control unit includes a buffer controller. The buffer controller performs a jump operation for transferring data unnecessary to be updated in the flash memory to an adjacent position of update data in the buffer memory when a size of data necessary to be updated in the flash memory is smaller than a size of a block of the flash memory. The update data is for replacing the data necessary to be updated in the flash memory.

The jump operation may include a direct memory access (DMA) operation from the flash memory to the buffer memory.

The buffer controller may include a jump table unit including one or more jump tables used for the jump operation. Each of the jump tables may include a jump start register and a jump target register. The jump start register may store ‘L−1’. L may be a start address of the update data in the buffer memory. The jump target register may store ‘M+1’. M may be an end address of the update data in the buffer memory.

The jump table unit may further include a jump table appointment register. The jump table appointment register may appoint one jump table of the jump tables. The one jump table may be used for corresponding jump operation

The jump table unit may further include a jump table enable register. The jump table enable register may enable the appointed jump table.

The jump table unit may further include a mode selection register. The mode selection register may determine whether the data unnecessary to be updated in the flash memory is written to the adjacent position of the update data in the buffer memory.

Each of the jump tables may be configured by randomly connecting spaces in the buffer memory.

The flash memory device may further include a host interface. The host interface may convert a control signal, an address signal and a data signal to internal signals for operating the flash memory. The control signal, the address signal and the data signal may be received from an external host.

The buffer memory may correspond to a random access memory (RAM).

The buffer memory may correspond to a static random access memory (SRAM).

The buffer memory may correspond to a dynamic random access memory (DRAM).

The control unit may further include a buffer memory controller and a flash memory controller. The buffer memory controller may control read and write operations of the buffer memory. The flash memory controller may control read and write operations of the flash memory.

In some example embodiments of the present invention, a flash memory system includes a host and a flash memory device. The flash memory device stores data or outputs the stored data according to a command of the host. The flash memory device includes a flash memory, a buffer memory and a control unit. The control unit includes a buffer controller. The buffer controller performs a jump operation for transferring data unnecessary to be updated in the flash memory to an adjacent position of update data in the buffer memory when a size of data necessary to be updated in the flash memory is smaller than a size of a block of the flash memory.

The flash memory system may further include a host interface. The host interface may convert a control signal, an address signal and a data signal to internal signals for operating the flash memory. The control signal, the address signal and the data signal may be received from an external host.

The buffer controller may further include a jump table unit including one or more jump tables used for the jump operation. Each of the jump tables may include a jump start register and a jump target register. The jump start register may store ‘L−1’. L may be a start address of the update data in the buffer memory. The jump target register may store ‘M+1’. M may be an end address of the update data in the buffer memory.

The jump operation may include a direct memory access (DMA) operation from the flash memory to the buffer memory.

The jump table unit may further include a jump table appointment register. The jump table appointment register may appoint one jump table of the jump tables. The one jump table may be used for corresponding jump operation.

The jump table unit may further include a jump table enable register. The jump table enable register may enable the appointed jump table.

The jump table unit may further include a mode selection register. The mode selection register may determine whether the data unnecessary to be updated in the flash memory is written to the adjacent position of the update data in the buffer memory.

Each of the jump tables may be configured by randomly connecting spaces in the buffer memory.

The control unit may further include a buffer memory controller and a flash memory controller. The buffer memory controller may control read and write operations of the buffer memory. The flash memory controller may control read and write operations of the flash memory.

In a method of updating data of a flash memory device including flash memory and buffer memory according to example embodiments of the present invention, update data is stored in the buffer memory. Whether a size of data necessary to be updated in the flash memory is smaller than a size of a block of the flash memory is determined. A jump operation for transferring data unnecessary to be updated in the flash memory to an adjacent position of the update data in the buffer memory is performed when the size of the data necessary to be updated in the flash memory is smaller than the size of the block of the flash memory.

Additionally, block of the flash memory may be erased and updated data may be programmed to the flash memory. The jump operation may include a direct memory access (DMA) operation from the flash memory to the buffer memory.

Therefore, a flash memory device and a flash memory system including a buffer memory and method of updating data of the flash memory device according to the present invention may simplify an update operation with a DMA operation and a performance of a system is enhanced.

### BRIEF DESCRIPTION OF THE DRAWINGS

FIG. 1A through FIG. 1D are diagrams illustrating a process of updating data in a conventional flash memory device including buffer memory.

FIG. 2 is a block diagram illustrating a flash memory device including a buffer memory according to an example embodiment of the present invention.

FIG. 3 is a block diagram illustrating the jump table unit in FIG. 2

FIG. 4A through FIG. 4D are diagrams illustrating a process of updating data in a flash memory device including a buffer memory according to an example embodiment of the present invention.

FIG. 5 is a block diagram illustrating a flash memory system including a buffer memory.

FIG. 6 is a flow chart illustrating a process of updating data in a flash memory device including a buffer memory.

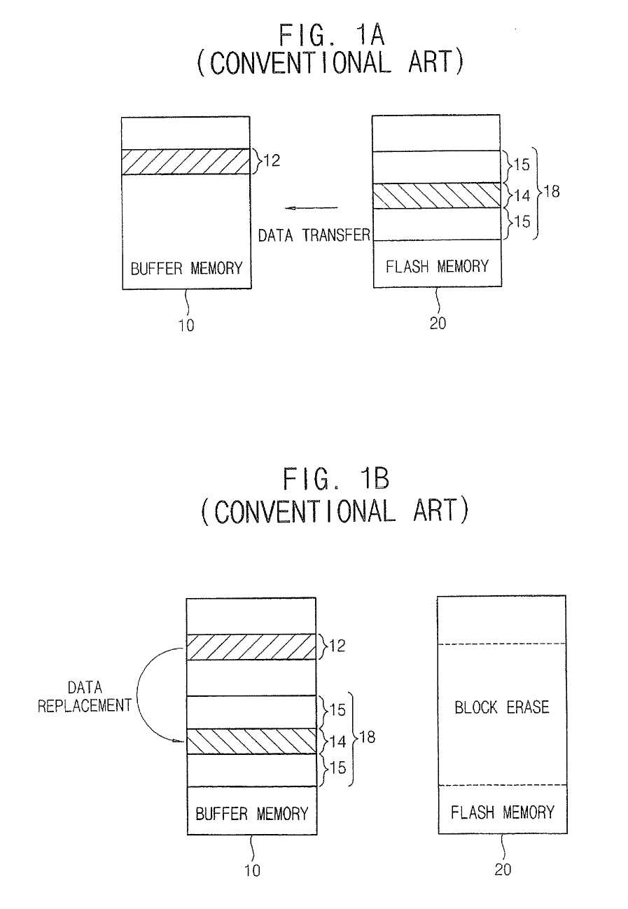

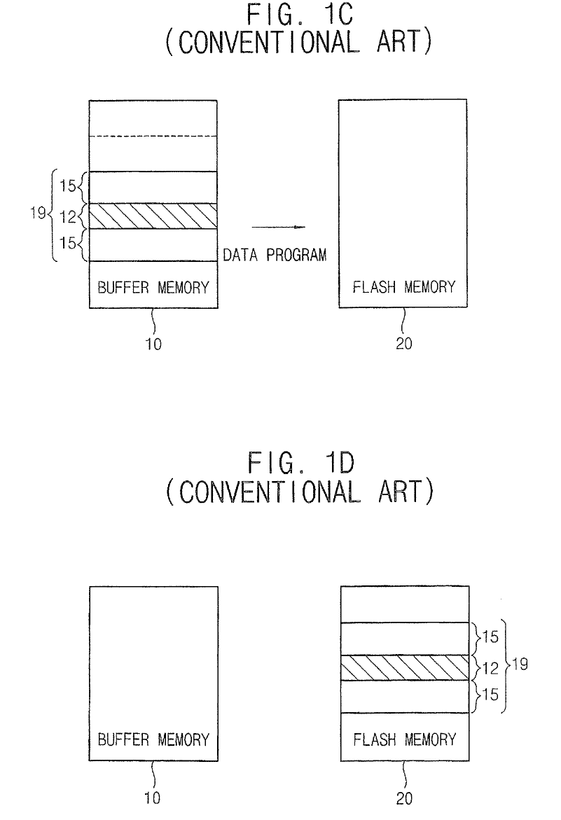

### DESCRIPTION OF THE EMBODIMENTS

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

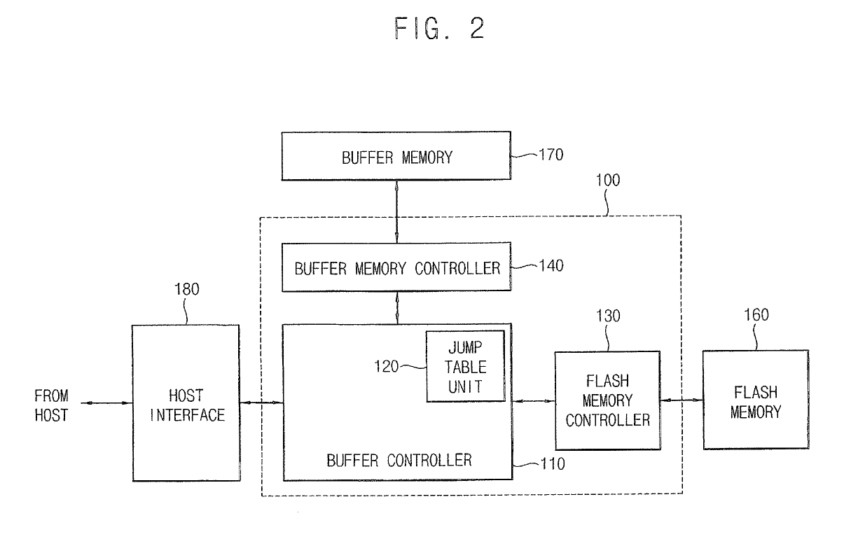

FIG. 2 is a block diagram illustrating a flash memory device including buffer memory according to an example embodiment of the present invention. Referring to FIG. 2, the flash memory device includes a control unit 100, a flash memory 160 and a buffer memory 170. The flash memory device may further include a host interface 180. The host interface 180 converts a control signal, an address signal and a data signal to internal signals for operating the flash memory 160. The control signal, the address signal and data signal are received from an external host.

The buffer memory 170 temporarily stores data that is to be stored in the flash memory 160 and data that is read from the flash memory 160. The buffer memory 170 is a static random access memory (SRAM), a dynamic random access memory (DRAM), or another type of volatile memory.

The control unit 100 includes a buffer controller 110 having a jump table unit 120. The control unit 100 further includes a flash memory controller 130 and a buffer memory controller 140. The flash memory controller 130 controls read and write operations of the flash memory 160. The buffer memory controller 140 controls read and write operations from and to the buffer memory 170.

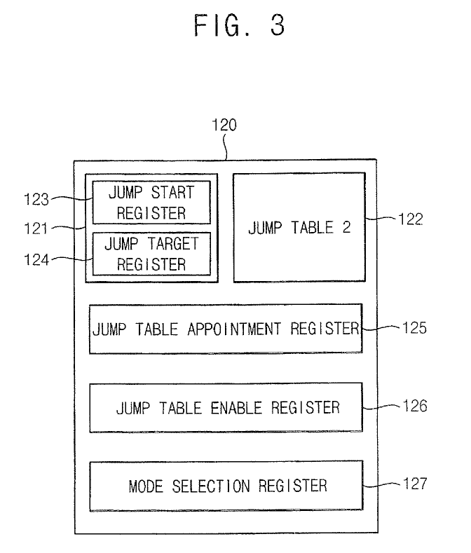

FIG. 3 is a block diagram illustrating the jump table unit in FIG. 2. Referring to FIG. 3, the jump table unit 120 includes one or more jump tables 121 and 122, a jump start register 123, a jump target register 124, a jump table appointment register 125, a jump table enable register 126 and a mode selection register 127.

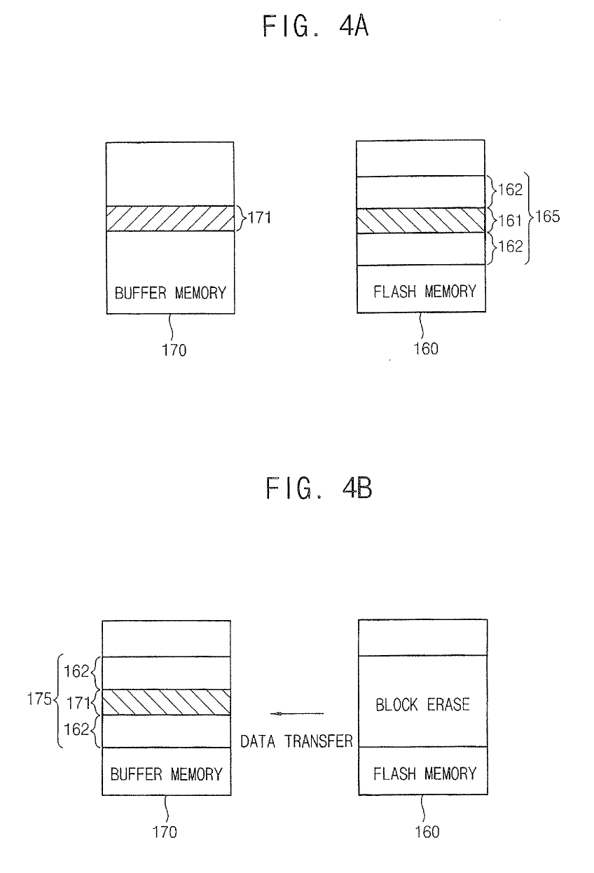

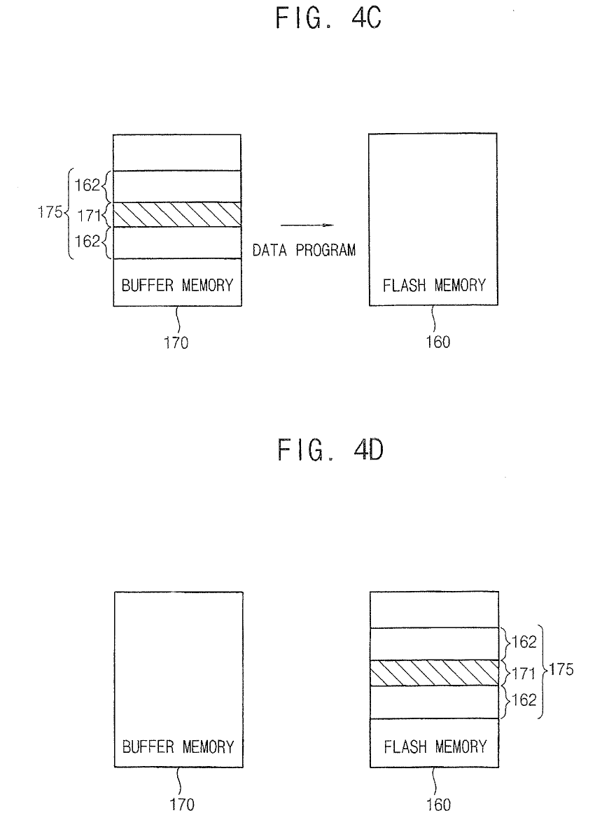

FIGS. 4A through 4D are diagrams illustrating a process of updating data in a flash memory device including a buffer memory according to an example embodiment of the present invention. When a size of data 161 necessary to be updated in the flash memory 160 is smaller than a size of a block 165 of the flash memory 160 as illustrated in FIG. 4A, a jump operation is performed by transferring data 162 unnecessary to be updated to at least one adjacent position of update data 171 in the buffer memory 170 as illustrated in FIG. 4B. The update data 171 is for replacing the data 161 necessary to be updated in the flash memory. Data is updated in the buffer memory 170 and the block 165, including the data 162 in the flash memory 160, is erased as illustrated in FIG. 4B. The updated data 175 is programmed to the flash memory 160 as illustrated in FIG. 4C. The update operation of data is finished as illustrated in FIG. 4D.

To achieve these update operations, the buffer controller 110 or firmware (not shown) compares a size of the update data 171 with the size of the block 165 of the flash memory 160 when the update operation is performed. The block 165 of the flash memory 160 is erased when the size of the block 165 of the flash memory 160 is not greater than the size of the update data 171. The updated data 175 is programmed to the erased block or another block. Then, the update operation is finished.

The jump table appointment register 125 appoints the jump table 121, which is used on a corresponding jump operation when the size of the update data 171 is smaller than the size of the block 165 of the flash memory 160. The jump table enable register 126 enables the appointed jump table 121. The appointed jump table 121 includes the jump start register 123 and the jump target register 124. The jump start register 123 stores ‘L−1’, where L is a start address of the update data 171. The jump target register 124 stores ‘M+1’, where M is an end address of the update data 171.

The jump operation represents transferring the data 162 unnecessary to be updated in the flash memory 160 to the adjacent position of the update data 171 of the buffer memory 170. The jump operation is performed based on the values stored in the jump start register 123 and the jump target register 124. The jump operation includes a direct memory access (DMA) operation from the flash memory 160 to the buffer memory 170.

The mode selection register 127 included in the jump table unit 120 may transfer the update data 171 to another portion of the buffer memory 170 when the update data 171 is in a write protection portion. The mode selection register 127 may also determine whether the adjacent position of the update data 171 is in the write protection portion, so as to determine whether the jump operation is performed during the DMA operation. Important information is stored in the write protection portion. The important information may be a boot code or other information that is used in the external host. As such, the important information stored in the buffer memory 170 is protected by the mode selection register 127. Each of the jump tables 121 and 122 may be configured by randomly connecting spaces in the buffer memory because each of the jump tables 121 and 122 stores an address of the buffer memory 170.

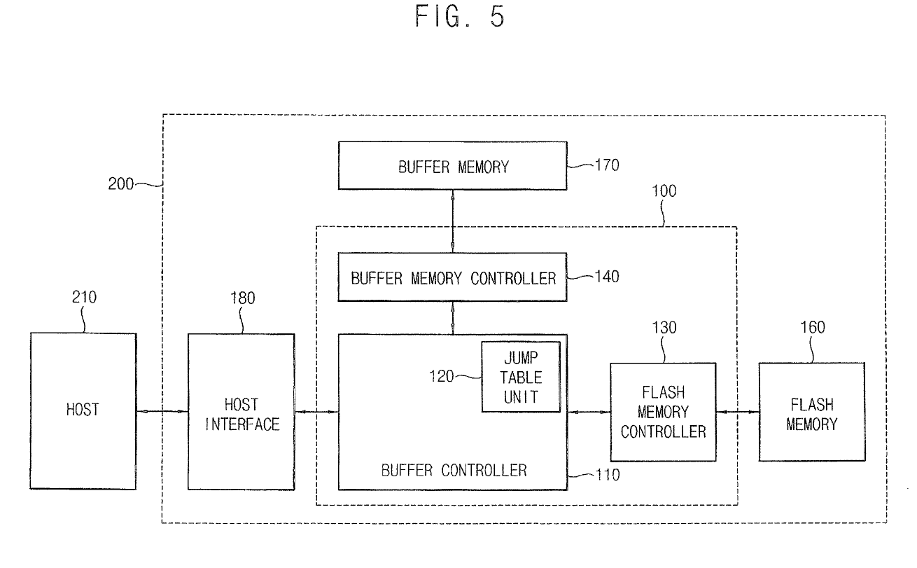

FIG. 5 is a block diagram illustrating a flash memory system including a buffer memory. Referring to FIG. 5, the flash memory system includes a host 210 and a flash memory device 200. The flash memory device 200 stores data or outputs the stored data according to a command of the host 210. The flash memory device 200 includes a host interface 180, a buffer controller 110 having a jump table unit 120, a flash memory 160, a flash memory controller 130, a buffer memory 170 and a buffer memory controller 140. Operations of the host interface 180, the buffer controller 110 having a jump table unit 120, a flash memory 160, a flash memory controller 130, a buffer memory 170 and the buffer memory controller 140 are equal to operations of those in FIG. 2.

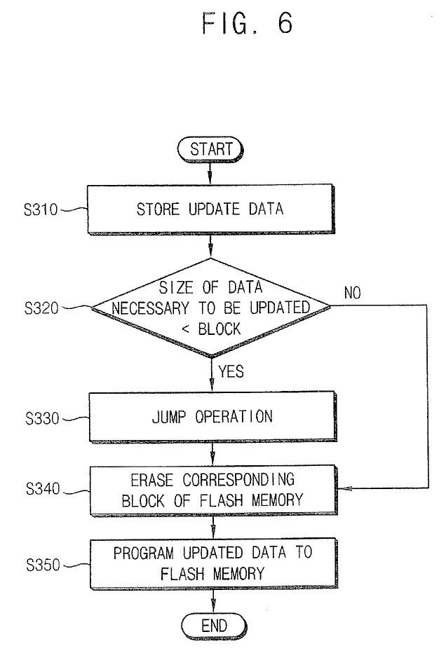

FIG. 6 is a flow chart illustrating a process of updating data in a flash memory device including a buffer memory. Referring to FIG. 6, update data is stored in a buffer memory (step S310). It is determined whether a size of data necessary to be updated in the flash memory is smaller than a size of a block of the flash memory (step S320). A jump operation is performed by transferring data unnecessary to be updated in the flash memory to an adjacent position of the update data in the buffer memory (S330) when the size of the data necessary to be updated in the flash memory is smaller than the size of the block of the flash memory (step S320: YES). Additionally, in the process of updating data of a flash memory device, the block of the flash memory where the data necessary to be updated has been stored is erased (step S340) and updated data in the buffer memory is programmed to the flash memory (step S350).

Hereinafter, the process of updating data of the flash memory device is described with reference to FIG. 2, FIG. 3, FIGS. 4A through 4D and FIG. 6. The buffer memory 170 receives the update data 171 from the external host and stores the update data 171 when the data 161 necessary to be updated is in the flash memory 170 (step S310). The size of the data 161 necessary to be updated or the size of the update data 171 is compared with the size of the block 165 including the data 161 necessary to be updated (step S320). When the size of the update data 171 is not smaller the size of the block 165 (step S320: NO), the block 165 of the flash memory 171 is erased (step S340). The updated data 175 is programmed to the erased block 165 or another block of the flash memory 160 and thus the update operation is finished.

When the size of the update data 171 is smaller than the size of the block 165 of the flash memory 160 (step S320: YES), the jump operation for transferring the data 162 unnecessary to be updated in the flash memory 160 to the adjacent position of the update data 171 in the buffer memory 170 is performed as illustrated in FIG. 4B (step S330). The jump operation may include the DMA operation. The block 165 including data 162 unnecessary to be updated is erased as illustrated in FIG. 4B (step S340). The updated data 175 is programmed to the flash memory 160 as illustrated in FIG. 4C (step S350). The update operation of data is finished as illustrated in FIG. 4D.

As described above, a flash memory device and flash memory system including a buffer memory and method of updating data of the flash memory device according to the present invention may simplify an update operation with a DMA operation. Therefore, performance of a system may be enhanced.

Having thus described example embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. An integrated circuit memory device, comprising:
a flash memory;
a buffer memory; and
a control circuit electrically coupled to said flash and buffer memories, said control circuit configured to write new data into a first block in said flash memory by transferring first data from the first block to said buffer memory and then transferring the first data and the new data from said buffer memory to the first block in said flash memory during a block write operation.

2. The memory device of Claim I, wherein transferring the first data from the first block to said buffer memory comprises writing the first data to said buffer memory; and wherein said control circuit is configured to write the new data to said buffer memory prior to writing the first data to said buffer memory.

3. The memory device of claim 1, wherein transferring the first data and the new data from said buffer memory to the first block in said flash memory during the block write operation is followed by erasing the first block of said flash memory.

4. The memory device of claim 1, wherein transferring the first data from the first block to said buffer memory comprises transferring all the data stored in the first block of said flash memory to said buffer memory; and wherein said control circuit is configured to write the new data to said buffer memory after transferring all the data stored in the first block to said buffer memory.

5. A flash memory device comprising:
a flash memory;
a buffer memory configured to temporarily store data that is to be stored in the flash memory or data that is read from the flash memory; and
a control unit including a buffer controller, the buffer controller being configured to perform a jump operation for transferring data unnecessary to be updated in the flash memory to an adjacent position of update data in the buffer memory when a size of data necessary to be updated in the flash memory is smaller than a size of a block of the flash memory, the update data being for replacing the data necessary to be up dated in the flash memory.

6. The flash memory device of claim 5, wherein the jump operation includes a direct memory access (DMA) operation from the flash memory to the buffer memory.

7. The flash memory device of claim 5, wherein the buffer controller comprises:
a jump table unit including one or more jump tables used for the JUMP operation, and
wherein each of the jump tables includes a jump start register and a jump target register, the jump start register storing ‘L−1’, L being a start address of the update data in the buffer memory, the jump target register storing ‘M+1’, M being an end address of the update data in the buffer memory.

8. The flash memory device of claim 7, wherein the jump table unit further comprises:
a jump table appointment register configured to appoint one jump table of the jump tables, and
wherein the one jump table is used for corresponding jump operation.

9. The flash memory device of claim 8, wherein the jump table unit further comprises:
a jump table enable register configured to enable the appointed jump table.

10. The flash memory device of claim 9, wherein the jump table unit further comprises:
a mode selection register configured to determine whether the data unnecessary to be updated in the flash memory is written to the adjacent position of the update data in the buffer memory.

11. The flash memory device of claim 7, wherein each of the jump tables is configured by randomly connecting spaces in the buffer memory.

12. The flash memory device of claim 5, further comprising:
a host interface configured to convert a control signal, an address signal and a data signal to internal signals for operating the flash memory,
wherein the control signal, the address signal and the data signal are received from an external host.

13. The flash memory device of claim 5, wherein the buffer memory corresponds to a random access memory (RAM).

14. The flash memory device of claim 13, wherein the buffer memory corresponds to a static random access memory (SRAM).

15. The flash memory device of claim 13, wherein the buffer memory corresponds to a dynamic random access memory (DRAM).

16. The flash memory device of claim 5, wherein the control unit further comprises:
a buffer memory controller configured to control read and write operations of the buffer memory; and
a flash memory controller configured to control read and write operations of the flash memory.

17. A flash memory system comprising:
a host; and
a flash memory device configured to store data or output the stored data according to a command of the host, the flash memory device comprising:
a flash memory;
a buffer memory configured to temporarily store data that is to be stored in the flash memory or data that is read from the flash memory; and
a control unit including a buffer controller, the buffer controller being configured to perform a jump operation for transferring data unnecessary to be updated in the flash memory to an adjacent position of update data in the buffer memory when a size of data necessary to be updated in the flash memory is smaller than a size of a block of the flash memory, the update data being for replacing the data necessary to be updated in the flash memory.

18. The flash memory system of claim 17, further comprises:
a host interface configured to convert a control signal, an address signal and a data signal to internal signals for operating the flash memory,
wherein the control signal, the address signal and the data signal are received from an external host.

19. The flash memory system of claim 17, wherein the buffer controller comprises:
a jump table unit including one or more jump tables used for the jump operation, and
wherein each of the jump tables includes a jump start register and a jump target register, the jump start register storing ‘L−1’, L being a start address of the update data in the buffer memory, the jump target register storing an ‘M+1’, M being an end address of the update data in the buffer memory.

20. The flash memory system of claim 17, wherein the jump operation includes a direct memory access (DMA) operation from the flash memory to the buffer memory.

21. The flash memory system of claim 19, wherein the jump table unit further comprises:
a jump table appointment register configured to appoint one jump table of the jump tables, and
wherein the one jump table is used for corresponding jump operation.

22. The flash memory system of claim 21, wherein the jump table unit further comprises:
a jump table enable register configured to enable the appointed jump table.

23. The flash memory system of claim 22, wherein the jump table unit further comprises:
a mode selection register configured to determine whether the data unnecessary to be updated in the flash memory is written to the adjacent position of the update data in the buffer memory.

24. The flash memory system of claim 19, wherein each of the jump tables is configured by randomly connecting spaces in the buffer memory.

25. The flash memory system of claim 17, wherein the control unit further comprises:
a buffer memory controller configured to control read and write operations of the buffer memory; and
a flash memory controller configured to control read and write operations of the flash memory.
